(19) United States
(12) Patent Application Publication
(10) Pub. No.: US 2008/0055214 A1
(43) Pub. Date: Mar. 6, 2008

(54) Display device and method for driving the same

(75) Inventors: Nam-Soo Kang, Ansan-si (KR); Myeong-Su Kim, Cheonan-si (KR); Haeng-Won Park, Seongnam-si (KR); Yong-Soon Lee, Cheonan-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/704,484

(22) Filed: Feb. 8, 2007

(30) Foreign Application Priority Data
Sep. 2, 2006 (KR) 10-2006-0012484

(51) Int. Cl. G09G 3/36

(52) U.S. Cl. 345/87

(57) ABSTRACT

A driver for driving a display device having a plurality of pixels connected to a plurality of data lines includes: a signal controller that creates a plurality of image signal groups and a plurality of identification codes corresponding to the plurality of image signal groups; and a plurality of data driving circuits each of which receives at least two identification codes of the plurality of identification codes and the image signal groups corresponding to the at least two identification codes, converts the image signals into data signals, and outputs the data signals to the data lines. In the driver, each of the data driving circuits compares the at least two identification codes, selects one of the image signal groups according to the result of the comparison, converts the image signals belonging to the one image signal group into the data signals, and outputs the other image signal groups to another data driving circuit. The identification codes are assigned to the image signal groups and the data driving integrated circuit selects the corresponding image signal group on the basis of the result of comparison between the identification codes, which makes it possible to prevent the image signal group from being transmitted to a non-corresponding data driving integrated circuit due to an error between the signal controller and the data driver.

### CROSS-REFERENCE TO RELATED APPLICATION

This application claims priority benefit of Korean Patent Application No. 10-2006-0012484 filed in the Korean Intellectual Property Office on Feb. 9, 2006, the entire contents of which are incorporated herein by reference.

### FIELD OF THE INVENTION

The present invention relates to a display device, and an apparatus and method for driving the same.

### DESCRIPTION OF THE RELATED ART

Flat panel devices include liquid crystal display (LCD), field emission display (FED), organic light emitting display (OLED), and a plasma display (PDP) devices. The flat panel display device includes a plurality of pixels for visually displaying image information, a plurality of signal lines for transmitting signals to the pixels, and a driver for driving the pixels. The driver includes a controller for processing image information into signals suitable for the display device and a plurality of driving circuits that receive digital image information from the controller, convert the digital image information into analog data voltages, and transmit the analog data voltages to the pixels through the signal lines.

The controller should control the driving circuit so as to reliably receive the image information to be processed by the driving circuit. In order for this operation, it is necessary that physical and spatial information on the driving circuit be exactly input to the controller. However, the information on the driving circuit that is input to the controller may be different from actual information. In this case, wrong image information may be input to the driving circuit, and thus a desired image may not be displayed.

### SUMMARY OF THE INVENTION

The present invention has been made in an effort to transmit exact image information between a controller and a driving circuit.

According to an exemplary embodiment of the present invention, a driver, which drives a display device having a plurality of pixels connected to a plurality of data lines, includes: a signal controller that creates a plurality of image signal groups and a plurality of identification codes corresponding to the plurality of image signal groups; and a plurality of data driving circuits each of which receives at least two identification codes of the plurality of identification codes and the image signal groups corresponding to the at least two identification codes, converts the image signals into data signals, and outputs the data signals to the data lines. In the driver, each of the data driving circuits compares the at least two identification codes, selects one of the image signal groups according to the result of the comparison, converts the image signals belonging to the one image signal group into data signals, and outputs the other image signal group to another data driving circuit.

Each of the data driving circuits may select the image signal group corresponding to one of the identification codes having a maximum value or a minimum value.

Each of the data driving circuits may include: an input unit that receives the plurality of image signal groups, compares the plurality of identification codes, and selects one of the plurality of image signal groups according to the result of the comparison; a data converting unit that converts the selected image signal group into data signals and outputs the data signals to the data lines; and an output unit that outputs the other image signal groups.

The driver may further include a first data transmission line group that includes a plurality of transmission lines connected between the signal controller and one of the data driving circuits.

The driver may further include a plurality of second data transmission line groups each of which includes at least one transmission line. In addition, the data driving circuits may be arranged in a line, and each of the second data transmission line groups may be connected between two data driving circuits adjacent to each other. Further, the number of transmission lines belonging to one data transmission line group may differ from the number of transmission lines belonging to another second data transmission line group. In this case, the two second data transmission line groups are connected among different data driving circuits.

The image signal groups may be transmitted through different transmission lines. Each of the transmission lines may include a plurality of signal lines transmitting different image signals, and the identification code may be transmitted through one of the signal lines.

According to another embodiment of the present invention, a display device includes: a plurality of pixels that are connected to gate lines and data lines; a gate driver that supplies gate signals to the gate lines; a signal controller that creates a plurality of image signal groups and a plurality of identification codes corresponding to the plurality of image signal groups; and a data driver that processes the image signal groups on the basis of the identification codes, converts image signals of the image signal groups into data signals, and outputs the data signals to the data lines. In the display device, the data driver includes a plurality of driving circuits, and compares the identification codes to designate one of the driving circuits that will process the corresponding image signal group.

Each of the data driving circuits may select the image signal group corresponding to one of the identification codes having a maximum value or a minimum value.

According to still another embodiment of the present invention, a method of driving a display device includes: receiving a plurality of identification codes and a plurality of image signal groups corresponding to the plurality of identification codes; comparing the plurality of identification codes; selecting one of the image signal groups on the basis of the result of the comparison; processing the selected image signal group to display an image; and outputting the image signal groups other than the selected image signal group. The selecting of the image signal group may include selecting the image signal group corresponding to one of the identification codes having a maximum value or a minimum value.

### BRIEF DESCRIPTION OF THE DRAWINGS

The foregoing and other objects and features of the present invention may become more apparent from a reading of the ensuing description together with the drawing, in which:

FIG. 1 is a block diagram illustrating a display device according to an exemplary embodiment of the present invention;

FIG. 2 is an equivalent circuit diagram of one pixel of a liquid crystal display;

FIG. 3 is a block diagram illustrating a data driver of a liquid crystal display;

FIG. 4 is a block diagram illustrating a data driving integrated circuit of a data driver;

FIG. 5 is a diagram illustrating the waveforms of signals transmitted to a data driving integrated circuit; and

FIG. 6 is a flowchart illustrating the operation of a data driving integrated circuit.

### DETAILED DESCRIPTION OF THE EMBODIMENTS

In the drawings, the thickness of layers, films, panels, regions, etc. are exaggerated for clarity. Like reference numerals designate like elements throughout the specification. It will be understood that when an element such as a layer, film, region or substrate is referred to as being “on” another element, it can be directly on the other element or intervening elements may also be present. In contrast, when an element is referred to as being “directly on” another element, there are no intervening elements present.

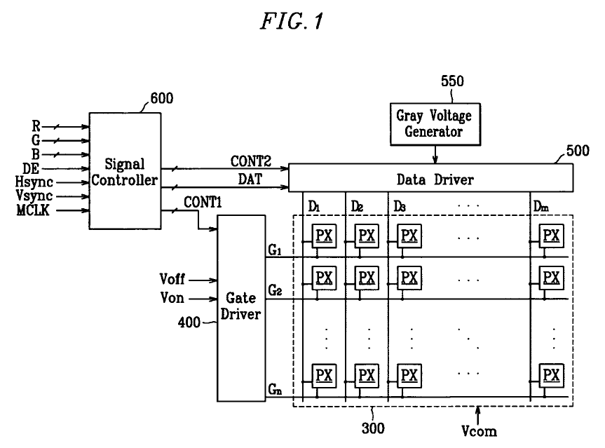

As shown in FIG. 1, the display device according to an exemplary embodiment of the present invention includes a display panel 300, a gate driver 400 and a data driver 500 that are connected to the display panel 300, a gray voltage generator 550 connected to the data driver 500, and a signal controller 600 for controlling these components.

As can be seen from the equivalent circuit diagram, the display panel 300 includes a plurality of signal lines G₁ to Gₙ and D₁ to Dₘ and a plurality of pixels PX that are connected to the plurality of signal lines and arranged substantially in a matrix.

The signal lines G₁ to Gₙ and D₁ to Dₘ are composed of a plurality of gate lines G₁ to Gₙ through which gate signals (referred to as “scanning signals”) are transmitted and a plurality of data lines D₁ to Dₘ through which data signals are transmitted. The gate lines G₁ to Gₙ extend in a row direction so as to be parallel to each other, and data lines D₁ to Dₘ extend in a column direction so as to be parallel to each other.

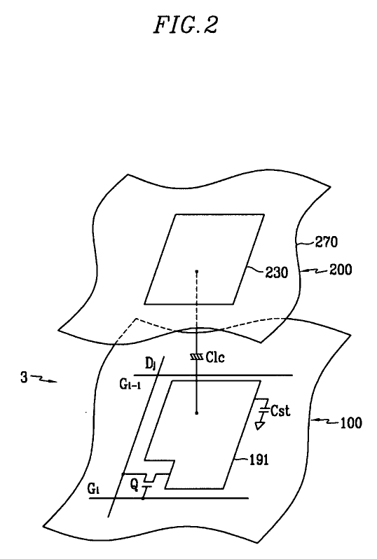

In the liquid crystal display shown in FIG. 2, the display panel 300 includes lower and upper panels 100 and 200 opposite to each other and a liquid crystal layer 3 interposed therebetween.

Each pixel PX of the liquid crystal display, for example, a pixel PX connected to an i-th (i=1, 2, . . . , n) gate line Gᵢ and a j-th (j=1, 2, . . . , m) data line Dⱼ includes a switching element Q connected to a signal line (Gᵢ, Dⱼ), a liquid crystal capacitor Clc connected to the switching element Q, and a storage capacitor Cst. The storage capacitor Cst may be omitted, if necessary.

The switching element Q is a three-terminal element, such as a thin film transistor, provided on the lower panel 100, and has a control terminal connected to the gate line Gᵢ, an input terminal connected to the data line Dⱼ, and an output terminal connected to the liquid crystal capacitor Clc and the storage capacitor Cst.

The liquid crystal capacitor Clc has a pixel electrode 191 provided on the lower panel 100 and a common electrode 270 provided on the upper panel 200 as two terminals, and the liquid crystal layer 3 interposed between the electrodes 191 and 270 serves as a dielectric material. The pixel electrode 191 is connected to the switching element Q. The common electrode 270 is formed on a front surface of the upper panel 200, and a common voltage Vcom is applied to the common electrode 270. Unlike the structure shown in FIG. 2, the common electrode 270 may be provided on the lower panel 100. In this case, at least one of the two electrodes 191 and 270 may be formed in a linear or rod shape.

The storage capacitor Cst, serving as an auxiliary member of the liquid crystal capacitor Clc, is a laminated structure of an additional signal line (not shown) provided on the lower panel 100, an insulator, and the pixel electrode 191 formed on the insulator, and a predetermined voltage, such as the common voltage Vcom, is applied to the additional signal line. Alternatively, the storage capacitor Cst may be a laminated structure of the pixel electrode 191, the insulator, and a gate line formed on the insulator.

In order to perform color display, each pixel PX specifically displays one of the primary colors (spatial division), or the pixels PX alternately display the primary colors with time (temporal division), which causes the primary colors to be spatially and temporally synthesized, thereby displaying a desired color. The primary colors may be composed of, for example, red, green, and blue. As an example of the spatial division, FIG. 2 shows that each pixel PX of the liquid crystal display has a color filter 230 for displaying one of the primary colors in a region of the upper panel 200 corresponding to the pixel electrode 191. Unlikely the structure shown in FIG. 2, the color filter 230 may be provided above or below the pixel electrode 191 of the lower panel 100.

At least one polarizer (not shown) for polarizing light is mounted to an outer surface of the display panel 300.

Referring to FIG. 1 again, a gray voltage generator 550 generates two pairs of gray voltage groups (or reference gray voltage groups) related to the transmittance of the pixel PX. One of the pairs of gray voltage groups has a positive value with respect to the common voltage Vcom, and the other pair of the gray voltage groups has a negative value with respect to the common voltage Vcom.

Gate driver 400 is connected to gate lines G₁ to Gₙ of display panel 300, and applies gate signals, each composed of a combination of a gate-on voltage Von and a gate-off voltage Voff.

Data driver 500 is connected to data line D₁ to Dₘ of display panel 300, selects the gray voltage generated by gray voltage generator 550, and applies the selected gray voltage as a data signal. The structure of data driver 500 will be described in detail below. Signal controller 600 controls gate driver 400 and data driver 500. Each of drivers 400, 500, 550, and 600 may be mounted on display panel 300 in the form of at least one IC chip, may be mounted on a flexible printed circuit film (not shown) and then mounted on display panel 300 in the form of a TCP (tape carrier package), or may be mounted on a separate printed circuit board (PCB) (not shown). Alternatively, drivers 400, 500, 550, and 600 may be mounted on display panel 300 together with, for example, signal lines G₁ to Gₙ and D₁ to Dₘ and the thin film transistor switching elements Q. Further, drivers 400, 500, 550, and 600 may be integrated into a single chip. In this case, at least one of the drivers or at least one circuit forming the drivers may be arranged outside the single chip.

Next, the operation of the display device will be described in detail below. Signal controller 600 receives from an external graphic controller (not shown) input image signals R, G, and B and input control signals for controlling the display of the input image signals R, G, and B. The input image signals R, G, and B include luminance information for each pixel PX, the luminance having a predetermined gray-scale level, for example, 1024 (=2¹⁰) gray-scale levels, 256 (=2⁸) gray-scale levels, or 64 (=2⁶) gray-scale levels. For example, any of the following signals may be used as the input control signal: a vertical synchronization signal Vsync, a horizontal synchronizing signal Hsync, a main clock MCLK, and a data enable signal DE.

Signal controller 600 processes the input image signals R, G, and B so as to be suitable for the operational condition of the display panel 300 on the basis of the input control signal to generate, for example, a gate control signal CONT1 and a data control signal CONT2. Then, signal controller 600 transmits gate control signal CONT1 to the gate driver 400 and transmits data control signal CONT2 and the processed image signal DAT to the data driver 500.

Gate control signal CONT1 includes a scanning start signal STV indicating the start of scanning and at least one clock signal for controlling the output cycle of the gate-on voltage Von. Gate control signal CONT1 may further include an output enable signal OE defining the duration of the gate-on voltage Von.

Data control signal CONT2 includes a horizontal synchronization start signal STH indicating that the transmission of the image signal DAT to a row of pixels PX starts, a load signal LOAD allowing data signals to be transmitted to data lines D₁ to Dₘ, and a data clock signal HCLK. In the liquid crystal display, data control signal CONT2 may further include an inversion signal RVS for inverting the polarity of an analog data signal voltage with respect to the common voltage Vcom (hereinafter, “the polarity of a data signal voltage with the common voltage” is simply referred to as “the polarity of a data signal voltage”).

Data driver 500 receives the image signal DAT for a row of pixels PX according to data control signal CONT2 transmitted from signal controller 600, selects a gray voltage corresponding to the image signal DAT, converts the digital image signal DAT into an analog data signal, and applies the analog data signal to data lines D₁ to Dₘ.

Gate driver 400 applies the gate-on voltage Von to the gate lines G₁ to Gₙ on the basis of gate control signal CONT1 from signal controller 600 to turn on the switching elements Q. The data signals applied to data lines D₁ to Dₘ are supplied to the corresponding pixels PX through the switching elements Q that are in an on state.

In the liquid crystal display shown in FIG. 2, the difference between the voltage of the data signal applied to the pixel PX and the common voltage Vcom is a pixel voltage that charges liquid crystal capacitor Clc. The alignment directions of liquid crystal molecules depend on the level of the pixel voltage, which causes the polarization of the liquid crystal layer 3 to vary. The variation in polarization causes a variation in the transmittance of light to the polarizer mounted to the display panel 300. In this way, the pixel PX displays a brightness corresponding to the gray-scale level of the image signal DAT.

These processes are repeatedly performed for every one horizontal period [which is referred to as “1H” and is equal to one period of the horizontal synchronizing signal Hsync and the data enable signal DE]. In this way, the gate-on voltage Von is sequentially applied to all the gate lines G₁ to Gₙ, and the data signals are supplied to all the pixels PX, thereby displaying one frame of images.

In the liquid crystal display, when one frame has ended, the next frame starts. In this case, the state of the inversion signal RVS applied to the data driver 500 is controlled such that the polarity of the data signal voltage applied to each pixel PX is reverse to the polarity of the data signal voltage in the previous frame (“frame inversion”). The polarity of the data signal voltage applied to one data line may be inverted in the same frame according to the characteristic of the inversion signal RVS (for example, row inversion and dot inversion), and the polarities of the data signal voltages applied to a row of pixels may be different from each other (for example, column inversion and dot inversion).

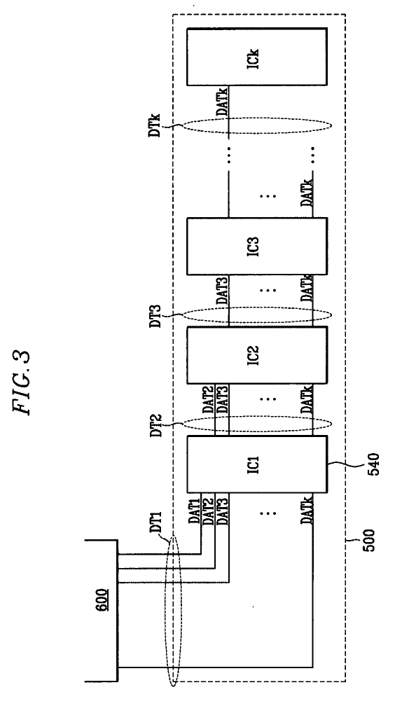

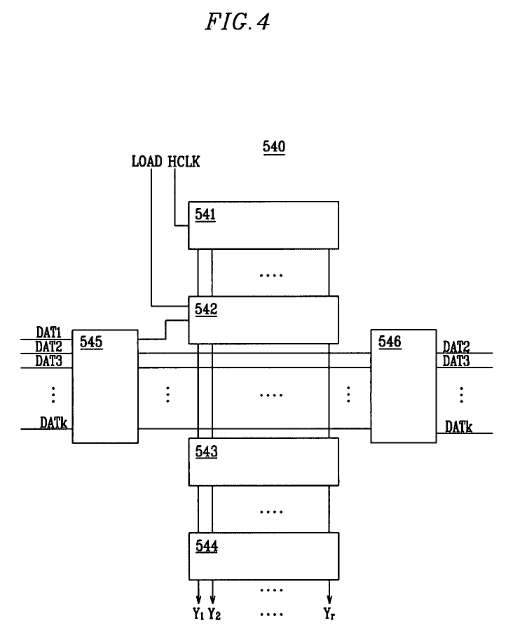

Next, the data driver will be described in detail below with reference to FIGS. 3 and 4.

FIG. 3 is a block diagram illustrating a data driver for a display device according to an exemplary embodiment of the present invention, and FIG. 4 is a block diagram illustrating the data driver.

Referring to FIG. 3, data driver 500 according to an exemplary embodiment of the present invention includes a plurality of data driving integrated circuits, for example, first to k-th data driving integrated circuits IC1, IC2, . . . , ICk (k is a natural number).

Data driving integrated circuits IC1, IC2, . . . , ICk are arranged in a row direction of display panel 300. Data transmission line groups DT1 to DTk each including at least one data transmission line are connected between signal controller 600 and the first data driving integrated circuit IC1 and between adjacent data driving integrated circuits IC1, IC2, . . . , ICk.

The number of data transmission lines belonging to the first data transmission line group DT1 arranged between signal controller 600 and the first data driving integrated circuit IC1 is equal to the number, k, of data driving integrated circuits IC1, IC2, . . . , ICk. The number of data transmission lines belonging to the data transmission line groups DT₁ to DTₖ is reduced one by one for each of the data driving integrated circuits IC1, IC2, . . . , ICk. Therefore, the number of data transmission lines belonging to a p-th data transmission line group DTₚ between a (p−1)-th data driving integrated circuit ICp−1 (p=2, . . . k) and a p-th data driving integrated circuit ICp is k+1-p. The number of data transmission lines belonging to the last data transmission line group DTk between the last data driving integrated circuit ICk and the data driving integrated circuit

ICk−1 previous to the last data driving integrated circuit is one.

Signal controller 600 transmits one image signal group DAT₁ to DATₖ allocated to one data driving integrated circuit IC1, IC2, . . . , ICk to k data transmission lines belonging to the first data transmission line group DT1 (hereinafter, the data transmission line belonging to a k-th transmission line group is referred to as a k-th transmission line).

Each of the data transmission lines has signal lines whose number is equal to the number of the primary colors displayed by the pixels PX of the display device. For example, when the input image signals R, G, and B input to signal controller 600 corresponding to the pixels PX displaying red, green, and blue (hereinafter, the pixels displaying red, green, and blue are referred to as a red pixel, a green pixel, and a blue pixel, respectively, and image signals related to these pixels are referred to as a red image signal, a green image signal, and a blue image signal, respectively). Each of the data transmission lines may include a red signal line (not shown) for transmitting the red image signal, a green signal line (not shown) for transmitting the green image signal, and a blue signal line (not shown) for transmitting the blue image signal. Each of the red, green, and blue signal lines may include sub-signal lines (not shown) whose number is equal to or smaller than the number of bits of the image signal.

In this structure, each of the data driving integrated circuits IC1, IC2, . . . , ICk receives only a necessary image signal group among the image signal groups DAT₁ to DATₖ and transmits the other image signal groups to the next data driving integrated circuit IC2, . . . , ICk through the data transmission lines.

For example, the first data driving integrated circuit (IC1) 540 receives k image signal groups DAT₁ to DATₖ from signal controller 600 through the first transmission line group DT₁. Then, the first data driving integrated circuit (IC1) 540 selects the first image signal group DAT1 required for the first data driving integrated circuit IC1 from the received image signal groups, and transmits the other (k−1) image signal groups DAT₂ to DATₖ to the second data driving integrated circuit IC2 through the second data transmission line group DT₂.

The p-th data driving integrated circuit ICp receives (k+1−p) image signal groups DATₚ to DATₖ from the previous data driving integrated circuit, that is, the (p−1)-th data driving integrated circuit ICₚ₋₁ through the p-th transmission line group DTₚ. Then, the p-th data driving integrated circuit ICp selects the p-th image signal group DATₚ from the received image signal groups, and transmits the other image signal groups DAT_{p+1 to DAT}ₖ to the next data driving integrated circuit ICₚ₊₁ through the (p+1)-th transmission line group DTₚ₊₁. The last k-th data driving integrated circuit ICp receives one image signal group DATₖ from the (k−1)-th data driving integrated circuit ICₖ₋₁ through the k-th transmission line group DTₖ and processes the received image signal group.

When the image signal groups DAT₁ to DATₖ are transmitted by such a cascading transfer method, the number of data transmission lines between adjacent data driving integrated circuits IC1, IC2, . . . , ICk are reduced one-by-one as the data driving integrated circuit becomes closer to the last stage ICk from signal controller 600. Therefore, it is possible to considerably decrease the number of wiring lines and thus reduce the number of logics by a number corresponding to the number of reduced wiring lines, which makes it possible to reduce the power consumption of the data driver 500.

Next, a data driving integrated circuit according to an exemplary embodiment of the present invention will be described in detail below with reference to FIG. 4. For better comprehension and ease of description, the first data driving integrated circuit among the data driving integrated circuits shown in FIG. 3 is shown in FIG. 4.

The first data driving integrated circuit (IC1) 540 includes an input unit (receiver) 545, an output unit (transmitter) 546, a shift register 541, a latch 542, a digital-to-analog converter 543, and an output buffer 544. The shift register 541, the latch 542, the digital-to-analog converter 543, and the output buffer 544 are connected to one another in this order.

The input unit 545 receives the first to k-th image signal groups DAT₁ to DATₖ from k first data transmission lines connected to signal controller 600, and selects the first image signal group DAT1 from the received image signal groups.

The output unit 546 is connected to the second data transmission lines, rearranges the second to k-th image signal groups DAT₂ to DATₖ other than the first image signal group DAT1 according to the data clock signal HCLK, and transmits the rearranged image signal groups to the second data driving integrated circuit IC2 through the second data transmission lines.

When a horizontal synchronization start signal (STH; or a shift clock signal) is input, shift register 541 transmits image signals of the first image signal group DAT1 selected according to the data clock signal HCLK to the latch 542. The shift register 541 transmits the shift clock signal to the shift register 541 of the next data driving integrated circuit IC2, . . . , ICk.

The latch 542 stores the image signals of the first image signal group DAT1 and transmits the image signals to the digital-to-analog converter 543 on the basis of the load signal LOAD.

The digital-to-analog converter 543 is supplied with a gray voltage from gray voltage generator 550, converts the digital image signals of the first image signal group DAT1 into analog voltages, and transmits the converted voltages to the output buffer 544.

The output buffer 544 outputs the voltages output from the digital-to-analog converter 543 to output ends Y1, Y2, . . . , Yr as data signals, and holds the data signals for one horizontal period.

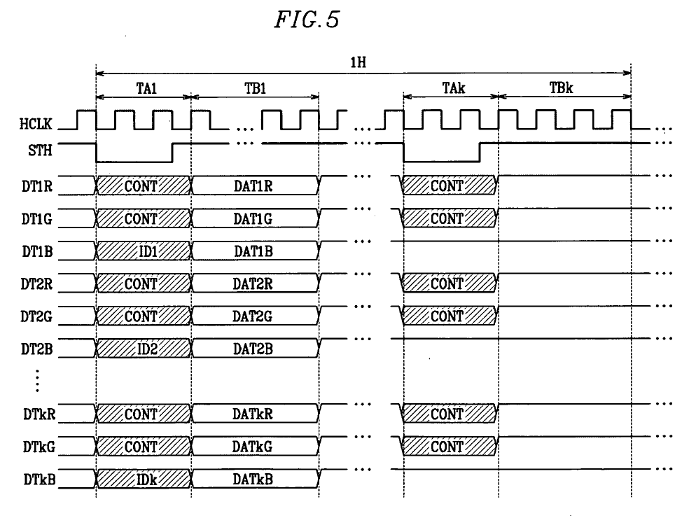

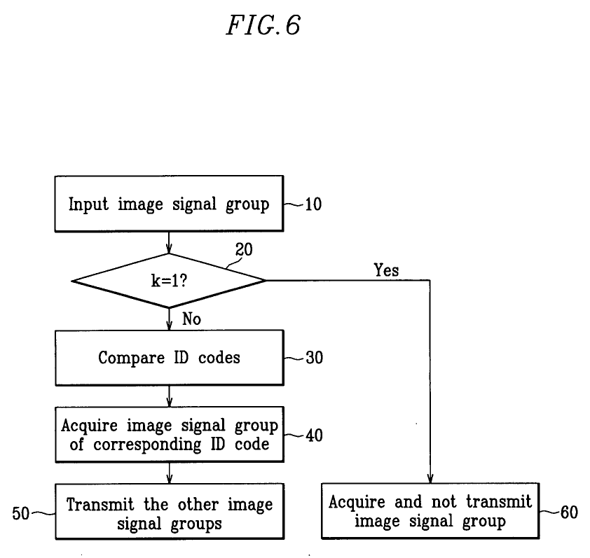

Hereinafter, an image signal transmitting operation of a signal controller and a data driving integrated circuit according to an exemplary embodiment of the present invention will be described with reference to FIGS. 5 and 6.

FIG. 5 is a diagram illustrating the waveforms of signals transmitted to the data driving integrated circuit, and FIG. 6 is a flowchart illustrating the operation of the data driving integrated circuit.

First, signal controller 600 divides the image signal DAT for a row of pixels into a plurality of image signal groups DAT₁ to DATₖ. The image signal groups DAT₁ to DATₖ each include image signals to be processed by one of the data driving integrated circuits IC1, . . . , ICk. Referring to FIG. 5, the image signal groups DAT₁ to DATₖ include red, green, and blue image signals DAT1R, DAT1G, DAT1B, . . . , DATkR, DATkG, and DATkB, respectively.

Signal controller 600 assigns to the image signal groups DAT₁ to DATₖ identification codes ID1, ID2, . . . , IDk related to the data driving integrated circuits IC1, IC2, . . . , ICk that will process the corresponding image signals, respectively, and transmits the identification codes and the corresponding image signal groups DAT₁ to DATₖ to the data driver 500. The first to k-th data driving integrated circuits IC1, . . . , ICk−1 in the data driver 500 read out the corresponding identification codes ID1, ID2, . . . , IDk, respectively, and select the corresponding image signal groups DAT₁ to DATₖ, respectively. In this case, for example, the first data driving integrated circuit IC1 transmits image signal groups other than the image signal group corresponding thereto to the next data driving integrated circuit IC2, . . . , ICk.

All the data driving integrated circuits IC1, . . . , ICk select the corresponding image signal groups DAT₁ to DATₖ according to the same rule, respectively. In order for this operation, a predetermined rule is made among the identification codes ID1, ID2, . . . , IDk.

For example, the order in which the data driving integrated circuits IC1, IC2, . . . , ICk are connected on the basis of signal controller 600 may be considered in making a rule among the identification codes ID1, ID2, . . . , IDk. It is unnecessary to separately assign unique identifiers to the data driving integrated circuits IC1, IC2, . . . , ICk. In addition, although the unique identifiers have already been assigned to the data driving integrated circuits IC1, IC2, . . . , ICk, the identifiers are not included in the identification codes ID1, ID2, . . . , IDk.

Therefore, even when the order in which the data driving integrated circuits IC1, IC2, . . . , ICk are connected is changed, or even when any one of the data driving integrated circuits IC1, IC2, . . . , ICk is removed, signal controller 600 determines the image signal groups DAT₁ to DATₖ to be processed according to the order where the data driving integrated circuits IC1, IC2, . . . , ICk are connected. In particular, when at least one of the data driving integrated circuits IC1, IC2, . . . , ICk is removed, the last image signal group is not selected.

The identification codes ID1, ID2, . . . , IDk each may have a binary value and may have different values. In this case, it is a rule that each of the data driving integrated circuits IC1, IC2, . . . , ICk can select only one of the identification codes ID1, ID2, . . . , IDk. For example, each of the data driving integrated circuits IC1, IC2, . . . , ICk selects one of the identification codes ID1, ID2, . . . , IDk having a minimum value. That is, for example, the data driving integrated circuit closest to the signal control 600 selects one of the image signal groups DAT₁ to DATₖ to which one of the identification codes ID1, ID2, . . . , IDk having a minimum value is assigned. On the other hand, when it is a rule that each of the data driving integrated circuits IC1, IC2, . . . , ICk can select one of the identification codes ID1, ID2, . . . , IDk having a maximum value, the data driving integrated circuit closest to the signal control 600 selects one of the image signal groups DAT₁ to DATₖ to which one of the identification codes ID1, ID2, . . . , IDk having a maximum value is assigned.

This operation will be described in detail below.

Referring to FIG. 5, when the horizontal synchronization start signal STH changes to a low level, signal controller 600 outputs the identification codes ID1, ID2, . . . , IDk and the control signal CONT to the data transmission lines belonging to the first data transmission line group DT₁ [a first period TA1]. At that time, the identification codes ID1, ID2, . . . , IDk and the control signal CONT are output to different signal lines. In FIG. 5, the control signal CONT is output to red signal lines DTRq (q=1, . . . k) and green signal lines DTGq, and the identification codes are output to blue signal lines DTBq.

The control signal CONT includes information on image signals to be subsequently transmitted. For example, the control signal CONT may include the horizontal synchronization start signal STH and a signal for determining the polarity of the voltage of a data signal or the load signal LOAD to be input to the latch 542.

When the horizontal synchronization start signal STH changes to a high level and then a predetermined clock cycle of the data clock signal HCLK, for example, a half clock cycle passes as shown in FIG. 5, a first data input period TB1 starts. Signal controller 600 transmits one of the image signal groups DAT₁ to DATₖ corresponding to the identification code ID1 to the data transmission lines belonging to the first data transmission line group DT₁.

Meanwhile, Referring to FIG. 6, the input unit 545 of the first data driving integrated circuit IC1 receives the identification codes ID1, ID2, . . . , IDk of the data transmission lines (10) and reads out the received identification codes (20). When the number of the identification codes is equal to one, i.e., k=1, the number of image signal groups is also one. Therefore, the input unit 545 of the first data driving integrated circuit IC1 receives and transmits the only image signal group DAT1 to the latch 542 (i.e., the first data driving integrated circuit IC1 acquires the image signal group DAT1) without sending the image signal group DAT1 to the output unit 546. Therefore, the first data driving integrated circuit IC1 transmits no image signal group to the second integrated circuit IC2 (60). When the number of the identification codes ID1, ID2, . . . , IDk is not equal to one (k≠1), the input unit 545 compares the identification codes ID1, ID2, . . . , IDk (30) with each other, and selects the image signal group DAT1 following one of the identification codes ID1, ID2, . . . , IDk that designates the input unit 545 (40). For example, the input unit 545 may select the image signal group DAT1 following the identification code ID1 having the minimum value among the identification codes ID1, ID2, . . . , IDk. The input unit 545 transmits image signals of the selected image signal group DAT1 to the latch 542, and the latch 542 stores the image signals of the image signal group DAT1.

The input unit 545 also transmits to the output unit 546 the other image signal groups DAT₂ to DATₖ following the identification codes ID2, . . . , IDk which are not connected with the input unit 545, and the output unit 546 transmits image signal groups DAT₂ to DATₖ to the second data driving integrated circuit IC2 through the second data transmission line groups DT₂ to DTₖ (50).

Meanwhile, when the identification codes ID1, ID2, . . . , IDk and the image signal groups DAT₁ to DATₖ are completely transmitted, signal controller 600 changes the shift clock signal STH to the low level again. At the same time, signal controller 600 outputs the control signal CONT to the data transmission lines belonging to the first data transmission line group DT1. For example, referring to FIG. 5, the control signal CONT is output to the red and green signal lines of the data transmission lines, but neither the control signal CONT nor the identification codes ID1, ID2, . . . , IDk are output to the blue signal line. After completing the output of the control signal CONT, signal controller 600 transmits invalid data or stops transmitting a valid signal for a predetermined time. Signal controller 600 repeatedly performs the output of the control signal CONT and the transmission of the invalid data several times.

The transmission of the image signal groups DAT₂ to DATₖ that are not selected by the first data driving integrated circuit IC1 and the corresponding identification codes ID2, . . . , IDk to the second data driving integrated circuit IC2 is simultaneously performed with the input of the second control signal CONT from signal controller 600. Then, the second data driving integrated circuit IC2 repeatedly performs the same operation as the first data driving integrated circuit IC1 performs, and the other data driving integrated circuits IC3, . . . , ICk are operated in the same manner as described above.

As described above, when each of the data driving integrated circuits IC1, . . . , ICk is set to select one of the identification codes ID1, . . . , IDk having a minimum value, the image signal group DAT1 corresponding to the identification code ID1 having a minimum value is selected first. In this way, the image signal groups DAT₂ to DATₖ are sequentially selected.

As described above, according to the present invention, instead of assigning identifiers to data driving integrated circuits, identification codes are assigned to image signal groups, and the data driving integrated circuits selects the image signal groups by means of comparison between the identification codes, which makes it possible to prevent the image signal group from being transmitted to a non-corresponding data driving integrated circuit due to an error between the signal controller and the data driver.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driver for a display device having a plurality of pixels connected to a plurality of data lines, the driver comprising:
a signal controller that creates a plurality of image signal groups and a plurality of identification codes corresponding to the plurality of image signal groups; and
a plurality of data driving circuits each of which receives at least two identification codes of the plurality of identification codes and the image signal groups corresponding to the at least two identification codes, converts the image signals into data signals, and outputs the data signals to the data lines,
wherein each of the data driving circuits compares the at least two identification codes, selects one of the image signal groups according to the result of the comparison, converts the image signals belonging to the one image signal group into the data signals, and outputs the other image signal groups to another data driving circuit.

2. The driver of claim 1, wherein each of the data driving circuits selects the image signal group corresponding to the one of the identification codes having a maximum value or a minimum value.

3. The driver of claim 1, wherein each of the data driving circuits includes:
an input unit that receives the plurality of image signal groups, compares the plurality of identification codes, and selects one of the plurality of image signal groups according to the result of the comparison;
a data converting unit that converts the selected image signal group into the data signals and outputs the data signals to the data lines; and
an output unit that outputs the other image signal groups.

4. The driver of claim 1, further comprising a first data transmission line group that includes a plurality of transmission lines connected between the signal controller and one of the data driving circuits.

5. The driver of claim 4, further comprising a plurality of second data transmission line groups each of which includes at least one transmission line, wherein:
the data driving circuits are arranged in a line;
each of the second data transmission line groups is connected between two data driving circuits adjacent to each other; and
the number of transmission lines belonging to one second data transmission line group differs from the number of transmission lines belonging to another second data transmission line group, the two second data transmission line groups being connected among different data driving circuits.

6. The driver of claim 5, wherein the image signal groups are transmitted through different transmission lines.

7. The driver of claim 6, wherein each of the transmission lines includes a plurality of signal lines transmitting different image signals, and the identification code is transmitted through one of the signal lines.

8. A display device comprising:
a plurality of pixels that are connected to gate lines and data lines;
a gate driver that supplies gate signals to the gate lines;
a signal controller that creates a plurality of image signal groups and a plurality of identification codes corresponding to the plurality of image signal groups; and
a data driver that processes the image signal groups on the basis of the identification codes, converts image signals of the image signal groups into data signals, and outputs the data signals to the data lines,
wherein the data driver includes a plurality of driving circuits, and compares the identification codes to designate one of the driving circuits that will process the corresponding image signal group.

9. The display device of claim 8, wherein each of the data driving circuits selects the image signal group corresponding to one of the identification codes having a maximum value or a minimum value.

10. A method of driving a display device, comprising:
receiving a plurality of identification codes and a plurality of image signal groups corresponding to the plurality of identification codes;
comparing the plurality of identification codes;
selecting one of the image signal groups on the basis of the result of the comparison;
processing the selected image signal group to display an image; and
outputting the image signal groups other than the selected image signal group.

11. The method of driving a display device of claim 10, wherein the selecting of the image signal group includes selecting the image signal group corresponding to the one of the identification codes having a maximum value or a minimum value.
